(19) United States
(12) Patent Application Publication
(10) Pub. No.: US 2024/0209950 A1
(43) Pub. Date: Jun. 27, 2024

(54) SWITCHOVER DEVICE

(71) Applicant: Nepoerl GmbH, Müllheim (DE)

(72) Inventor: Yichao BIAN, Müllheim (DE)

(73) Assignee: Neoperl GmbH, Müllheim (DE)

(21) Appl. No.: 17/913,909

(22) PCT Filed: Feb. 24, 2021
(86) PCT No.: PCT/EP2021/054574

§ 371 Date: Sep. 23, 2022

(30) Foreign Application Priority Data
Apr. 9, 2020 (DE) 20 2020 101 989.9

(51) Int. Cl. F16K 11/07

(52) U.S. Cl. CPC F16K 11/07

(57) ABSTRACT

A switchover device (1) for selectively connecting a first opening (2) to a second opening (3) is provided, with the switchover device (1) including a piston (4) and a piston chamber (5) for receiving the piston (4), the piston chamber (5) having at least the first opening (2), wherein the piston (4) has a seal (6), preferably a sealing disk, which can be moved past the first opening (2), and wherein the piston chamber (5) has, in a piston chamber section (7), a widening of a clear internal dimension, in particular an internal diameter (8) of the piston chamber (5).

### TECHNICAL FIELD

The invention relates to a switchover device for selectively connecting a first opening to a second opening, the switchover device comprising a piston and a piston chamber for receiving the piston, the piston chamber comprising at least the first opening, wherein the piston comprises a sealing device, preferably a sealing disk, which can be moved past the first opening.

### BACKGROUND

Such switchover devices are used, for example, in sanitary outlet fittings in which a common inlet can be selectively connected to a first outlet or a second outlet. The first outlet often opens into a fixed outflow, for example into a bathtub, and the second outlet opens into a shower. In this case, as a rule, a switchover is frequently made between the two selectable connections. This results in wear on the components encompassed by the switchover device.

### SUMMARY

The underlying object of the invention is that of reducing the wear caused by the use of the switchover device and thus of extending the service life of the switchover device.

In order to achieve the stated object, one or more of the features of disclosed herein are proposed according to the invention. In particular, the proposal according to the invention, in the case of a switchover device of the type described at the outset, is thus that the piston chamber has, in one piston chamber section, a widening of a clear internal dimension, in particular of an internal diameter, of the piston chamber.

The invention is based on the recognition that the movement of the sealing device within the piston chamber section subjects the sealing device and the inner wall of the piston chamber section to frictional forces. This results in wear. By providing a widening of a clear internal dimension, it is possible to ensure that the sealing device comes into contact, or into contact in a manner which fulfills the sealing function, with the inner wall of the piston chamber section only in those sub-sections of the piston chamber in which the sealing function is necessary for the functioning of the switchover device. In the remaining sub-sections, the sealing device does not come into contact, or into contact in a manner which fulfills the sealing function, with the inner wall of the piston chamber section when the sealing device moves. Thus, the wear on the switchover device is reduced and its service life is extended.

The clear internal dimension can be specified, for example, as characterizing a dimension of the piston chamber transversely to a direction of movement of the piston. For example, the clear internal dimension can be a clear internal diameter, in particular a maximum, minimum or average internal diameter in the case of a non-circular cross section or the internal diameter in the case of a cylindrical piston chamber.

The switchover device can have, for example, a third opening or even further openings, which can be fluidically connected to the first opening and/or the second opening, selectively or jointly.

In an advantageous embodiment, provision can be made for the piston chamber section to comprise the first opening. As a result, a clear internal dimension in the region of the first opening is enlarged in order to be able to reliably prevent contact between the first opening and the sealing device. It is best if the widening begins outside the first opening. The widening can be designed so as to be completely outside the first opening or so as to project partially into a region of the first opening, for example.

In an advantageous embodiment, provision can be made for the piston chamber section to have a narrowing of the widened clear internal dimension, wherein the first opening is preferably arranged between the widening and the narrowing. Thus, a leaktight seal can be achieved by the sealing device in a direction of movement beyond the first opening.

In an advantageous embodiment, provision can be made for the piston chamber to have the clear internal dimension in front of and behind the piston chamber section. Thus, a leaktight seal of the sealing device beyond the first opening can be achieved. In other words, the narrowing of the widened internal dimension is designed oppositely to the widening of the internal dimension. The narrowing thus inverts or reverses the widening.

In addition, wear on the switchover device, in particular of the sealing device, which occurs during the movement of the sealing device past the peripheral edge or boundary of the first opening, where the abrasion and frictional forces are particularly high, is thereby reduced.

In an advantageous embodiment, provision can be made for the sealing device to comprise an elastic sealing ring, preferably an elastic O-ring.

The elastic sealing ring reduces the wear caused by frictional forces between the inner wall of the piston chamber and the piston. Moreover, the elasticity of the sealing ring ensures that the wear which ensues occurs mainly on the sealing ring. This is easily exchangeable. In this way, the service life of the switchover device can be extended further.

In an advantageous embodiment, provision can be made for the first opening to be fluidically separated from the second opening in a first position of the sealing device, and for the first opening to be fluidically connected to the second opening in a second position of the sealing device, and for the first opening to be fluidically connected to a third opening in the first position of the sealing device, and for the first opening to be fluidically separated from the third opening in the second position of the sealing device.

For example, the first position of the sealing device lies between the first and the second opening and the second position of the sealing device lies between the first and the third opening. In order to switch over between the connection of the first opening to the second opening and the connection of the first opening to the third opening, therefore, all that is required is a movement of the sealing device past the first opening. The wear on the sealing device is likewise kept low by the small movement of the sealing device, especially when the piston chamber section comprises the first opening.

In an advantageous embodiment, provision can be made for the clear internal dimension of the piston chamber to change uniformly, in particular continuously, within the piston chamber section.

In this way, a discontinuous transition between the clear internal dimension and the widened clear internal dimension is prevented. Particularly high abrasion and frictional forces could occur at such a transition.

In an advantageous embodiment, provision can be made for the piston chamber to comprise a first piston chamber part and a second piston chamber part, which can be joined or is joined to the first piston chamber part.

In an advantageous embodiment, provision can be made for the first piston chamber part or the second piston chamber part to at least partially comprise the piston chamber section, or for the first piston chamber part and the second piston chamber part to each partially comprise the piston chamber section.

In an advantageous embodiment, provision can be made for the first piston chamber part or the second piston chamber part to at least partially comprise the first opening, or for the first piston chamber part and the second piston chamber part to each partially comprise the first opening.

By producing two separate cylinder parts, it is possible, in particular, for the transitions between the clear internal dimension and the widened clear internal dimension to be produced with high precision and thus to ensure low abrasion and frictional forces between the piston and the piston chamber.

In one embodiment of the invention, provision can be made for the widening to be formed on the first piston chamber part. It is advantageous here that the widening can be introduced without undercuts, which simplifies production.

In this case, provision can be made for the narrowing to be formed on the second piston chamber part. It is advantageous here that the narrowing can also be introduced without undercuts, which simplifies production.

It is accordingly advantageous, particularly for the production of the switchover device, if a separation point at which the first piston chamber part is joined to the second piston chamber part is located between the widening and the narrowing.

In an advantageous embodiment, provision can be made for the first piston chamber part to comprise a sleeve for receiving the second piston chamber part, in particular wherein the sleeve delimits the widening.

In particular, provision can be made in this case for the sleeve to be taken past the third opening already mentioned and/or to be open at the third opening and for a through-opening to be formed. The plug-in sleeve thus forms the outlet.

In an advantageous embodiment, provision can be made for the first piston chamber part and the second piston chamber part each to comprise at least one connecting element for, in particular releasably, connecting the first piston chamber part to the second piston chamber part, wherein the at least one connecting element lies outside the piston chamber section. In other words, the connecting elements and are arranged outside a region which is delimited by the widening and the narrowing.

This has the advantage that the first opening is designed to be spatially separate from the connecting elements. A particularly pressure-resistant connection can thereby be produced. This ensures that the switchover device withstands high pressures at the first opening, which can be connected to an inlet.

### BRIEF DESCRIPTION OF THE DRAWINGS

The invention is now described in greater detail by means of exemplary embodiments, but it is not restricted to these exemplary embodiments. Further exemplary embodiments can be obtained by combining the features of one or more claims and/or one or more features of the exemplary embodiments.

In schematic illustrations:

FIG. 1 shows a bistable switchover device according to a first exemplary embodiment with a piston in a first position,

FIG. 2 shows the bistable switchover device according to the first exemplary embodiment with the piston in a second position,

FIG. 3 shows a switchover system comprising the bistable switchover device according to the first exemplary embodiment with the piston in the first position,

FIG. 4 shows the switchover system comprising the bistable switchover device according to the first exemplary embodiment with the piston in the second position,

FIG. 5 shows a three-dimensional illustration and an exploded illustration of the switchover device according to the first exemplary embodiment,

FIG. 6 shows a monostable switchover device according to a second exemplary embodiment with a piston in a first position,

FIG. 7 shows a three-dimensional illustration and an exploded illustration of the switchover device according to the second exemplary embodiment,

FIG. 8 shows a monostable switchover device according to a third exemplary embodiment with a piston in a first position, and

FIG. 9 shows a three-dimensional illustration and an exploded illustration of the switchover device according to the third exemplary embodiment.

### DETAILED DESCRIPTION

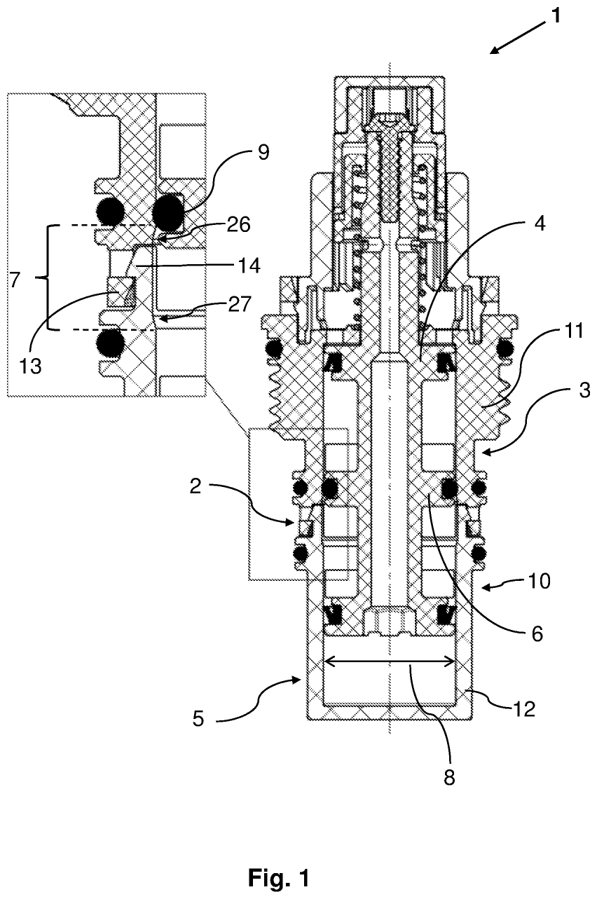

FIG. 1 shows a bistable switchover device, denoted by 1, according to a first exemplary embodiment. The switchover device 1 has a first opening 2, which can be connected, for example, to an inlet. The switchover device 1 has a second opening 3, which can be connected, for example, to a first outlet. Furthermore, the switchover device 1 has a third opening 10, which can be connected, for example, to a second outlet. Alternatively, the first opening 3 can be connected to an outlet, the second opening 3 can be connected to a first inlet and the third opening 10 can be connected to a second inlet, for example.

The switchover device 1 comprises a piston 4. The piston 4 is accommodated by a piston chamber 5. The piston chamber 5 comprises the first, second and third openings 2, 3 and 10. The piston chamber 5 is, for example, a piston cylinder with a circular base surface. The base surface of the piston chamber can likewise be configured as an ellipse or polygon, for example.

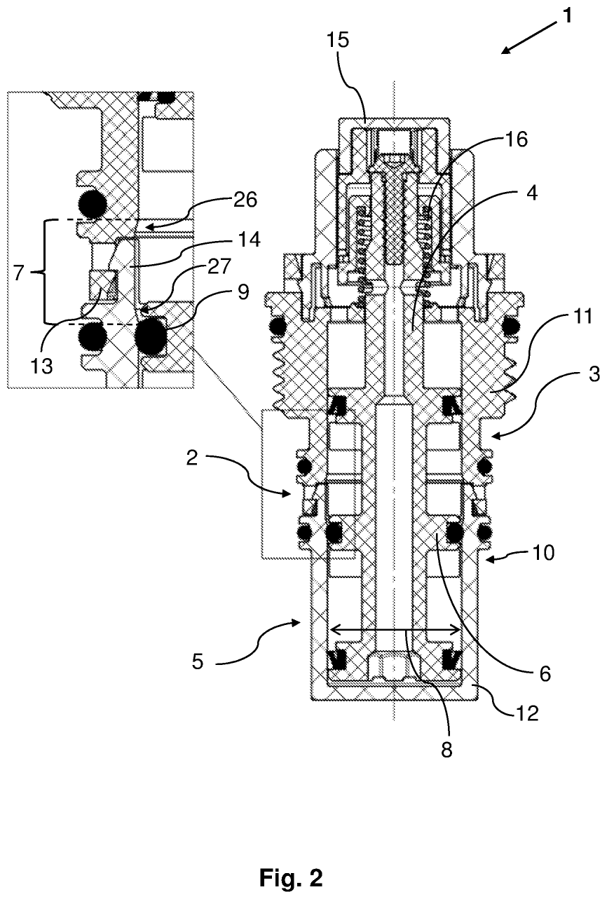

The piston 4 can be moved within the piston chamber 5. The piston 4 can be moved in translation along a longitudinal axis of the piston chamber 5. The movement of the piston 4 within the piston chamber 5 is limited by an upper and a lower side wall as well as by a piston chamber jacket. The piston 4 can be moved only along the longitudinal axis, in particular from a first position to a second position. FIG. 1 shows the piston 4 in the first position. FIG. 2 shows the piston in the second position.

The piston 4 comprises a sealing device 6, which can be designed as a sealing disk or perforated sealing disk around a longitudinal axis of the piston 4. The sealing device 6 comprises an elastic sealing ring 9. The sealing device 6 or sealing ring 9 are, for example, circular, elliptical or polygonal. In the illustrated first position of the piston 4, the elastic sealing ring 9 is in contact with the inner wall of the piston or with the piston chamber jacket. This is, in particular, because an external dimension, in this case an external diameter, of the elastic sealing ring 9 encompassed by the sealing device 6 is larger than a clear internal dimension, in this case the clear internal diameter, 8 of the piston chamber 5. The elastic sealing ring 9 is deformed and/or compressed by the contact which fulfills the sealing function.

The piston chamber 5 comprises a piston chamber section 7 which has a widening 26 of the internal dimension. The piston chamber section 7 furthermore has a narrowing 27 of the widened internal dimension. The widening 26 and the narrowing 27 can be designed as stepwise or uniform widening or narrowing. The narrowing 27 is designed as converse to the widening 26. The narrowing 27 inverts or reverses the widening 26. The sealing device 6, in particular the elastic sealing ring 9, can be moved over the widening 26 and over the narrowing 27, in particular can be moved over the piston chamber section 7.

In the exemplary embodiment illustrated, the widened internal dimension between the widening 26 and the narrowing 27 is constant. The piston chamber section 7 accordingly comprises a widened section, in which the clear internal dimension of the piston section 7 remains substantially unchanged, that is to say is constant.

In other words: the piston chamber 5 comprises a first sub-section and a second sub-section, wherein the first sub-section is arranged in front of and/or behind the second sub-section and the second sub-section is arranged between the widening 26 and the narrowing 27, and wherein the first sub-section has a, in particular constant, first clear internal dimension and the second sub-section has a, in particular constant, second clear internal dimension, and wherein the first clear internal dimension is smaller than the second clear internal dimension.

In other words: the piston section 7 comprises two transitional sections formed at the edge of the piston section 7, wherein the internal dimension, in particular the internal diameter of the transitional sections, changes continuously from the clear internal dimension of the piston section 7 to the clear internal dimension of the piston chamber 5, and vice versa. Alternatively, the clear internal dimension of the piston section 7 can change continuously from a minimum value to a maximum value, and vice versa, in particular without the piston section 7 having a widened section with a constant clear internal dimension.

In the switchover device 1 shown, the piston chamber section 7 comprises the first opening 2. The first opening 2 is of the widened section of the piston chamber section 7. The widening 26 and/or the narrowing 27 can likewise project into the opening or be arranged in front of or behind the opening in the direction of movement of the piston 4.

If the sealing device 6 is moved past the first opening 2, e.g. the piston 4 is moved into the second position (see FIG. 2), the elastic sealing ring 9 is deformed and/or compressed less while it is located in the piston chamber section 7, in particular at the level of the widened clear internal dimension of the piston section 7. The widened clear internal dimension in the piston section 7 can be larger than the external dimension, in this case than the external diameter of the elastic sealing ring 9 encompassed by the sealing device 6. In this way, the elastic sealing ring 9 does not come into contact or comes into attenuated contact with the inner wall of the piston chamber 5, at least in parts of the piston section 7. The elastic sealing ring 9 consequently slides or “flies” past the piston section 7, in particular past the first opening 2, without or virtually without friction occurring between the sealing ring 9 and the inner wall of the piston chamber 5.

In this way, the wear on the sealing ring 9 and/or the piston chamber 5 caused by friction is reduced. Moreover, the movement of the sealing device 6 over the piston section 7, in particular from the first position to the second position of the piston 4, and vice versa, is possible with less expenditure of force owing to the reduced frictional force. The switchover device 1 is thus, on the one hand, more durable and, on the other hand, easier to operate.

FIG. 2 shows the switchover device, denoted by 1, from FIG. 1. Identical features are provided with the same reference signs. In the switchover device 1 illustrated in FIG. 2, the piston 4 is in the second position. The above-described first and second positions of the piston 4 are, in particular, first and second stop positions, wherein the first stop position is defined by a boundary of the piston chamber 5 on a first boundary (first side wall), which runs perpendicular to the longitudinal axis of the piston chamber 5, on one side of the piston chamber 5, and the second stop position is defined by a second boundary (second side wall) of the piston chamber 5 on a side of the piston chamber 5 which is located opposite the first boundary.

### Piston Chamber Parts

As illustrated in FIGS. 1 and 2, the piston chamber 5 consists of a first piston chamber part 11 and a second piston chamber part 12. The first and second piston chamber parts 11 and 12 are connectable, for example connectable by means of a frictional, positive or material connection, in particular connectable by means of connecting elements that can be released (non-destructively) from one another. In the exemplary embodiment illustrated in FIG. 2, the first and second piston chamber parts 11 and 12 are connected by means of a first connecting element 13 encompassed by the first piston chamber part 11 and a second connecting element 14 encompassed by the second piston chamber part 12. The interengaging connecting elements 13 and 14 are each designed in the form of barbs and form a snap connection, thus ensuring a firm and secure connection which is, at the same time, capable of being released and reconnected. The connecting elements 13 and 14 can likewise be designed as a thread and can form a screw connection.

The first piston chamber part 11 or the second piston chamber part 12 can comprise the piston chamber section 7. Alternatively, the first piston chamber part 11 and the second piston chamber part 12 can each partially comprise the piston chamber section 7. In particular, the first piston chamber part 11 can comprise the widening 26 and the second piston chamber part 12 can comprise the narrowing 27.

Likewise, the first piston chamber part 11 or the second piston chamber part 12 can comprise a peripheral edge delimiting the first opening. Alternatively, the first piston chamber part 11 and the second piston chamber part 12 can each partially comprise the peripheral edge and, after the first and second piston chamber parts 11 and 12 have been joined together, each partially comprise the first opening or form the first opening.

In particular, as illustrated in FIG. 2, the first connecting element 13 and the second connecting element 14 can be surrounded by the piston chamber section 7. Furthermore, the connecting element 13 or the connecting element 14 can comprise the peripheral edge delimiting the first opening. Alternatively, the first connecting element 13 and the second connecting element 14 can each partially comprise the peripheral edge and, after the connecting elements 13 and 14 have been joined together, each partially comprise the first opening or form the first opening.

The division of the piston chamber 5 into two parts offers the possibility of providing the widening 26 and narrowing 27 of the clear internal dimension of the piston chamber 5 with high precision. This is particularly the case when the piston chamber section 7 or a part of the piston chamber section 7 is located at the outer edge of at least one of the piston chamber parts 11 and 12. Simplified and precise production of the piston chamber parts 11 and 12 and thus of the piston chamber 5 is thereby ensured.

In one exemplary embodiment (not illustrated), the piston chamber 5 can comprise a plurality of piston sections 7, in each of which the piston chamber 5 has a widening 26 of the clear internal dimension and a narrowing 27 of the widened clear internal dimension. In particular, the plurality of piston sections 7 can each comprise an opening in the piston chamber, for example in each case one of the first opening 2, the second opening 3 and the third opening 10. Here, an opening in the piston chamber 5 is, in particular, an opening in the piston chamber jacket.

The piston 4 can be moved from the first position to the second position by actuating an actuating device 15 and can be locked in the second position. The piston 4 can be moved from the second position to the first position by means of a return device 16. The return device 16 is, for example, a spring element.

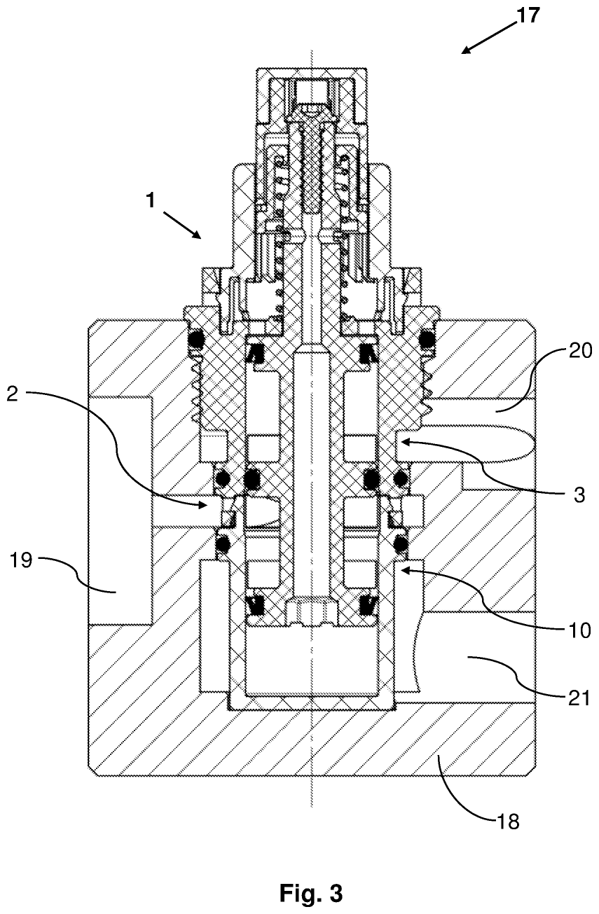

FIG. 3 shows a switchover system comprising the switchover device 1 illustrated in FIGS. 1 and 2 and a channel system 18 for receiving the switchover device 1. The switchover device 1 is fixedly connectable or connected to the channel system 18, in particular by means of a frictional, positive or material connection.

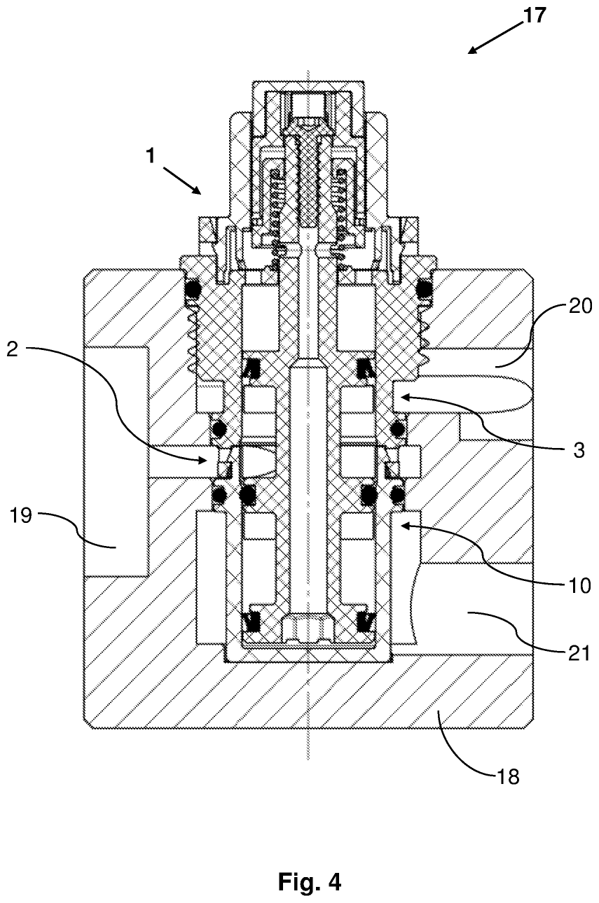

The channel system 18 comprises an inlet 19, a first outlet 20 and a second outlet 21. The switchover device 1 is connected to the channel system 18 in such a way that the first opening 2 of the switchover device 1 is fluidically connected to the inlet 19, the second opening 3 of the switchover device 1 is fluidically connected to the first outlet 20, and the third opening 10 of the switchover device 1 is fluidically connected to the second outlet 21. In this manner, in the illustrated first position of the piston 4 or of the sealing device 6, the inlet 19 is fluidically separated from the first outlet 20 and spatially fluidically connected to the second outlet 21. Similarly, in a second position (see FIG. 4) of the piston 4 or sealing device 6, the inlet 19 is fluidically separated from the second outlet 21 and fluidically connected to the first outlet 20.

FIG. 4 shows the switchover system, denoted by 17, from FIG. 3 with the piston 4 in the second position. Identical features are provided with the same reference signs.

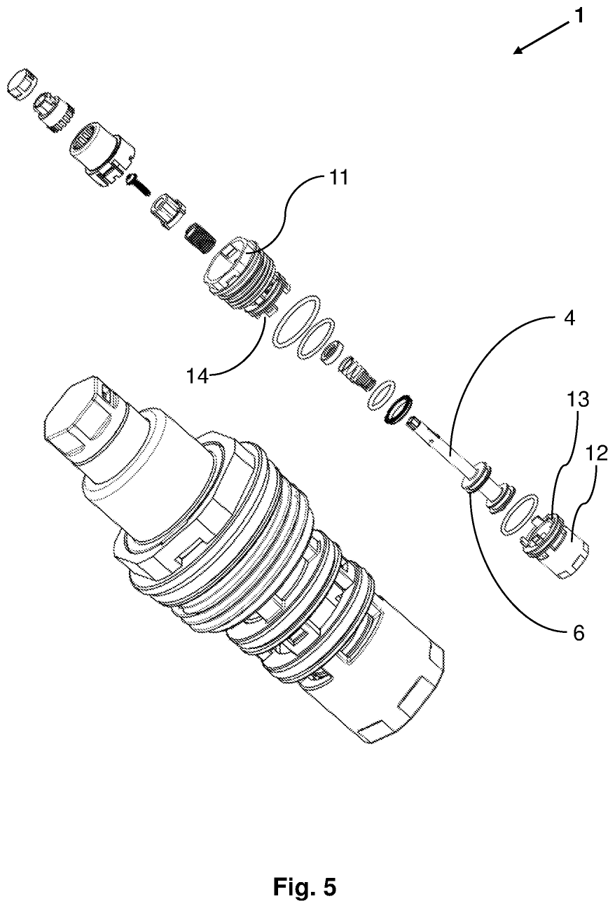

FIG. 5 shows a three-dimensional illustration and an exploded illustration of the switchover device, denoted by 1, from FIGS. 1 and 2. Identical features are provided with the same reference signs.

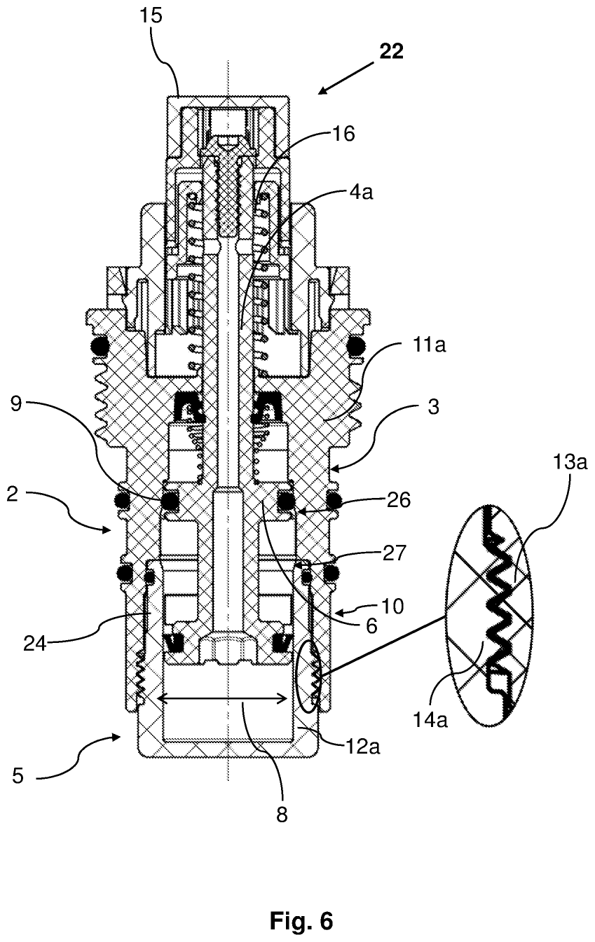

FIG. 6 shows a monostable switchover device, denoted by 22, according to a second exemplary embodiment. Switchover device 22 is similar to switchover device 1. In this respect, attention is drawn to the above description. Here, identical or similar features are provided with the same reference signs. One difference with respect to switchover device 1 is that switchover device 22 has a first piston chamber part 11a and a second piston chamber part 12a, wherein the first piston chamber part 11a comprises a sleeve 24 for receiving the second piston chamber part 12a.

The first and second piston chamber parts 11a and 12a can be connected or are connected via a screw connection. The first piston chamber part 11a comprises a first connecting element 13a, here a screw thread. The sleeve 24 of the second piston chamber part 12a comprises a second connecting element 14a, here a sleeve thread. The first and second connecting elements 13a and 14a are arranged outside the piston chamber section 7, in particular outside the widened section.

The sleeve 24 extends from connecting element 14a to the widened section of the piston chamber section 7. The first piston chamber part 11a comprises the widened section, and the widened section is delimited by the sleeve 24. The first and second piston chamber sections 11a and 12a each comprise the widening 26 or the narrowing 27 of the internal dimension of the piston chamber 5. In the exemplary embodiment shown, the first piston chamber part 11a comprises the widening 26 and the second piston chamber part 12a comprises the narrowing 27. The first piston chamber part 11a comprises the widened section in the piston chamber section 7, the first opening 2 and the second opening 3. The first and second piston chamber parts 11a and 12a comprise the third opening 10.

Corresponding to the third opening 10, the sleeve 24 has a through-opening 25 in order to form an outlet or inlet.

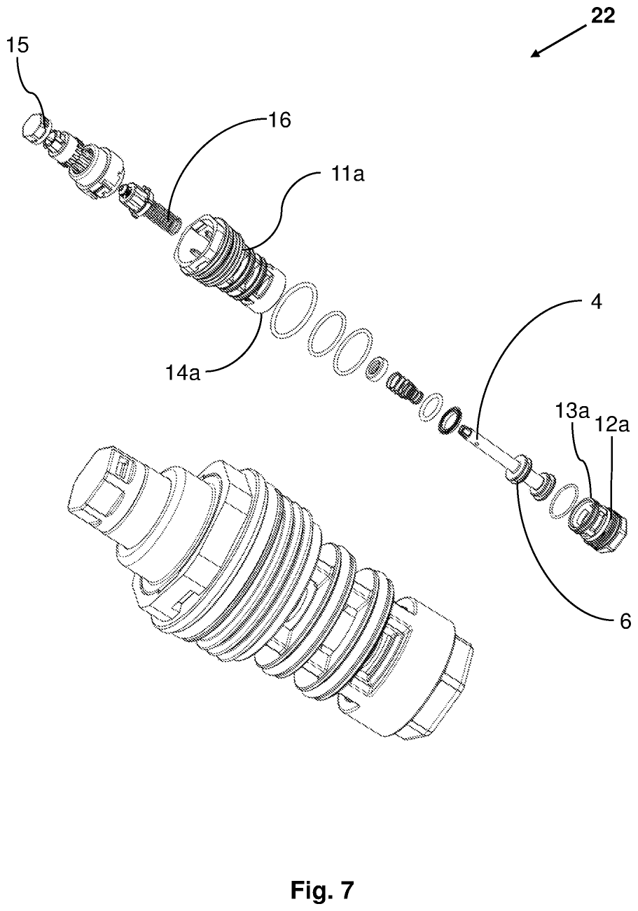

FIG. 7 shows a three-dimensional illustration and an exploded illustration of the switchover device, denoted by 22, from FIG. 6. Identical features are provided with the same reference signs.

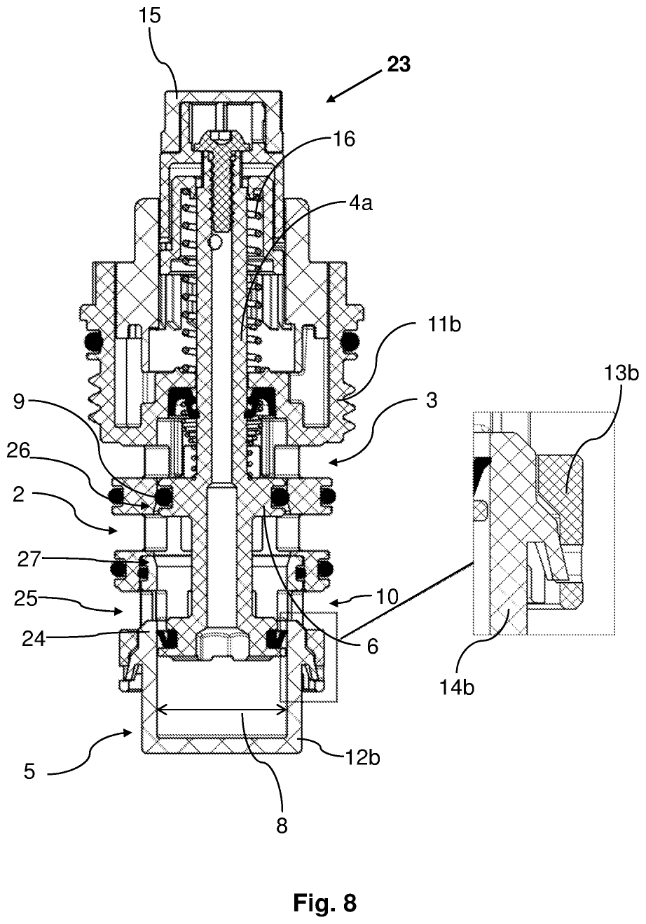

FIG. 8 shows a monostable switchover device, denoted by 23, according to a third exemplary embodiment. Switchover device 23 is similar to switchover device 22 and switchover device 1. In this respect, attention is drawn to the above description. Identical or similar features are provided with the same reference signs. Switchover device 23 has a first piston chamber part 11b and a second piston chamber part 12b, wherein the first piston chamber part 11b comprises a sleeve 24 for receiving the second piston chamber part 12b.

One difference from switchover device 22 is that the first and second piston chamber parts 11b and 12b can be connected or are connected via a snap connection. The first piston chamber part 11b comprises a first connecting element 13b, the sleeve 24 of the second piston chamber part 12b comprises a second connecting element 14b. The first connecting element 13b comprises a snap hook which latches into a recess, in particular an undercut, of the second connecting element 14b in the connected state of the piston chamber parts 11b and 12b. The first and second connecting elements 13b and 14b are arranged outside the piston chamber section 7, in particular outside the widened section.

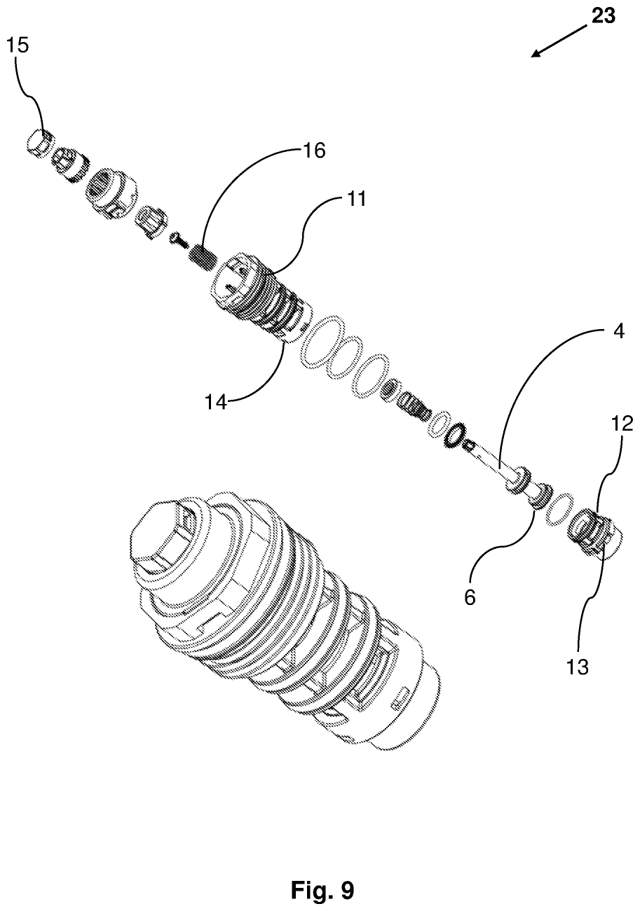

FIG. 9 shows a three-dimensional illustration and an exploded illustration of the switchover device, denoted by 23, from FIG. 6. Identical features are provided with the same reference signs.

### LIST OF REFERENCE SIGNS

1 bistable switchover device according to the first exemplary embodiment
2 first opening
3 second opening
4 piston of the bistable switchover device according to the first exemplary embodiment
4a piston of the monostable switchover device according to the second and third exemplary embodiments
5 piston chamber
6 sealing device
7 piston chamber section
8 clear internal diameter of the piston chamber
9 elastic sealing ring
10 third opening
11 first piston chamber part according to the first exemplary embodiment
11a first piston chamber part according to the second exemplary embodiment
11b first piston chamber part according to the third exemplary embodiment
12 second piston chamber part according to the first exemplary embodiment
12a second piston chamber part according to the second exemplary embodiment 12
12b second piston chamber part according to the third exemplary embodiment
13 first connecting element according to the first exemplary embodiment
13a first connecting element according to the second exemplary embodiment
13b first connecting element according to the third exemplary embodiment
14 second connecting element according to the first exemplary embodiment
14a second connecting element according to the second exemplary embodiment
14b second connecting element according to the third exemplary embodiment
15 actuating device
16 return device
17 switchover system
18 channel system
19 inlet
20 first outlet
21 second outlet
22 monostable switchover device according to the second exemplary embodiment
23 monostable switchover device according to the third exemplary embodiment
24 sleeve
25 through-opening
26 widening
27 narrowing

1. A switchover device (1) for selectively connecting a first opening (2) to a second opening (3), the switchover device (1) comprising:
a piston (4) comprising a seal (6);
a piston chamber (5) for receiving the piston (4), the piston chamber (5) comprising at least the first opening (2),
wherein the seal is movable past the first opening (2); and
the piston chamber (5) has, in one piston chamber section (7), a widening (26) of a clear internal dimension of the piston chamber (5).

2. The switchover device as claimed in claim 1, wherein the piston chamber section (7) comprises the first opening (2).

3. The switchover device as claimed in claim 2, wherein the piston chamber section (7) has a narrowing of the widened clear internal dimension, and the first opening is arranged between the widening (26) and the narrowing (27).

4. The switchover device as claimed in claim 1, wherein the piston chamber (5) has the clear internal dimension in front of and behind the piston chamber section (7) with the widening.

5. The switchover device as claimed in claim 1, wherein the seal (6) comprises an elastic sealing ring (9).

6. The switchover device as claimed in claim 1, wherein the first opening (2) is fluidically separated from a second opening (3) in a first position of the seal (6), and the first opening (2) is fluidically connected to the second opening (3) in a second position of the seal (6), and the first opening (2) is fluidically connected to a third opening (10) in the first position of the seal (6), and the first opening (2) is fluidically separated from the third opening (10) in the second position of the seal (6).

7. The switchover device as claimed in claim 1, wherein the clear internal dimension of the piston chamber (5) changes uniformly within the piston chamber section (7).

8. The switchover device as claimed in claim 1, wherein the piston chamber (5) comprises a first piston chamber part (11) and a second piston chamber part (12) joined to the first piston chamber part (11).

9. The switchover device as claimed in claim 8, wherein the first piston chamber part (11) or the second piston chamber part (12) at least partially comprises the piston chamber section (7).

10. The switchover device as claimed in claim 9, wherein the first piston chamber part (11) or the second piston chamber part (12) at least partially comprises the first opening (2).

11. The switchover device as claimed in claim 8, wherein the widening (26) is formed on the first piston chamber part (11).

12. The switchover device as claimed in claim 8, wherein the first piston chamber part (11) comprises a sleeve (24) for receiving the second piston chamber part (12).

13. The switchover device as claimed in claim 12, wherein the sleeve (24) delimits the widening (26).

14. The switchover device as claimed in claim 8, wherein the first piston chamber part (11) comprises a first connecting element (13) and the second piston chamber part (12) comprises a second connecting element (14) connecting the first piston chamber part (13) to the second piston chamber part (14), and the first and second connecting elements (13, 14) are arranged outside the piston chamber section.

15. The switchover device as claimed in claim 8, wherein the first piston chamber part (11) and the second piston chamber part (12) each partially comprise the piston chamber section (7).

16. The switchover device as claimed in claim 15, wherein the first piston chamber part (11) and the second piston chamber part (12) each partially comprise the first opening (2).
